(19) United States
(12) Patent Application Publication
(10) Pub. No.: US 2006/0269734 A1
(43) Pub. Date: Nov. 30, 2006

(54) Coated Insulation Articles and Their Manufacture

(75) Inventors: Mark T. Krajewski, Newton, MA (US); Brian Robert Betty, Nashua, NH (US); Daniel L. Leeser, Framingham, MA (US)

Correspondence Address: ASPEN AEROGELS INC.;IP DEPARTMENT, 30 FORBES ROAD, BLDG. B, NORTHBOROUGH, MA, 01532, US

(73) Assignee: Aspen Aerogels Inc., Northborough, MA (US)

(21) Appl. No.: 11/279,987

(22) Filed: Apr. 17, 2006

Related U.S. Application Data
(60) Provisional application No. 60/594,541, filed on Apr. 15, 2005.

(51) Int. Cl. B32B 27/04; B32B 5/02; B32B 3/26; B32B 5/22

(52) U.S. Cl. 428/304.4; 442/120; 442/126; 442/131; 428/317.9; 428/318.4

(57) ABSTRACT

Embodiments of the present invention describe an aerogel composite and method for preparing the same. The aerogel composite comprises an aerogel material; a fibrous structure interpenetrating with said aerogel material; and a coating comprising a polymeric material disposed about at least one surface of said aerogel material.

### CROSS REFERENCE TO RELATED APPLICATIONS

This application claims benefit of priority from U.S. Provisional Patent Application 60/594,541 filed on Apr. 15, 2005 which is hereby incorporated by reference in its entirety as if fully set forth.

### FIELD OF THE INVENTION

This invention pertains to organic polymer coated aerogel composites and methods for preparing the same.

### SUMMARY OF THE INVENTION

Embodiments of the present invention describe a composite comprising: an aerogel material; a fibrous structure interpenetrating with said aerogel material; and a coating comprising a polymeric material disposed about at least one surface of said aerogel material. The corresponding method of preparing the same comprises the steps of: Substantially incorporating a fibrous structure within an aerogel material thereby forming a composite; and coating at least one side of said composite with a polymeric material. Pre coating steps include plasma and corona treatments while post-coating steps include curing, drying or sintering. Suitable coating methods include: knife over roll coating, dip coating, saturation coating, reverse roll coating, direct roll coating, gravure coating, printing rotary screen coating, curtain coating, die coating extrusion coating, spray coating, transfer coating, electrostatic coating, brush coating, vapor deposition, flocking, hot knife coating, or hot melt coating. In a preferred embodiment, the coating is aqueous based. Said coating may also comprise a cross-linking agent, organic solvent, comprise acrylic based polymers which may or may not be in powder form. The coating may comprise: polyethylene, kapton, polyurethane, polyester, natural rubber, synthetic rubber, hypalon, plastic alloys, PTFE, polyvinyl halides, polyester, neoprene, acrylics, nitriles, EPDM, EP, viton, vinyls, vinyl-acetate, ethylene-vinyl acetate, styrene, styrene-acrylates styrene-butadienes, polyvinyl alcohol, polyvinylchloride, acrylamids, phenolics or a combination thereof. The fibrous structure can comprise organic polymer-based fibers, inorganic fibers or a combination thereof in forms such as woven, non-woven, mat, felt, batting, chopped fibers or a combined form. Aerogel materials may be based on organic, inorganic or hybrid organic-inorganic materials. Inorganic aerogels include silica, titania, zirconia, alumina, hafnia, yttria, ceria, carbides, nitrides or a combination thereof. Organic aerogels include aerogel material comprises urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, melamine-formaldehyde, phenol-furfural, a polyether or combinations thereof. Hybrid organic inorganic aerogels include: silica-PMMA, silica-chitosan, silica-polyether or any combination thereof. Opacification of aerogels can be achieved with compounds such as: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

### BRIEF DESCRIPTION OF THE DRAWINGS

FIG. 1 shows an aerogel composite's preparation, optional surface-modification, coating and, drying, curing or sintering. The coating and subsequent treatment may be repeated for as many iterations as desired. It is noted that the final post-coating processes may not be required for some embodiments wherein the coating is effective as applied. That is, the coating properties do not required further modification after deposition. In some instances the coating may dry or cure under ambient atmospheres.

FIG. 2 shows a continuous process for coating an aerogel composite wherein the uncoated aerogel composite 2 is coated with a coating mechanism 4, exemplified by spray coating without any implied limitation. The coated aerogel composite 6 is then conveyed though an oven 8 resulting in the finished coated aerogel composite 10.

FIG. 3, similar to FIG. 2, displays a coating process with the exception of being a discontinuous method. Accordingly, a discrete piece of aerogel composite is coated and processed in a serious of independent steps.

### DESCRIPTION

Aerogels are among the best known insulating materials today. However, due to the low density structure (often >90% air), these materials are often fragile. Furthermore, “dusting”, an event where surface particulates of the aerogel readily release into the surrounding atmosphere has been observed with some aerogels. Hence it is desirable to protect aerogel materials from external elements, reduce dusting therefrom, and improve mechanical properties in general among other aspects. A promising method for improving performance of aerogels involves coating of an aerogel material with a polymeric substance.

Within the context of embodiments of the present invention “aerogels” or “aerogel materials” along with their respective singular forms, refer to gels containing air as a dispersion medium in a broad sense, and include gels processed via supercritical drying in a narrow sense. Production of aerogels involves replacing the liquid solvent phase within the pores of a wet gel (gels with liquid-filled pores) with air, preferably without allowing substantial collapse of the pore structure. Although the sol-gel process is the preferred gel preparation method in certain embodiments of the present invention, other methods such as the “water glass process” are equally applicable. The water glass process is described in U.S. Pat. Nos. 5,759,506 and 6,210,751 both hereby incorporated by reference. Sol-gel process is described in detail in Brinker C. J., and Scherer G. W., Sol-Gel Science; New York: Academic Press, 1990; hereby incorporated by reference.

In an example involving the sol-gel process, a wet silica gel is prepared from polymerization (i.e. gellation) of the silica precursors in a sol solution. The resultant gel may be subject to a post-gelling processes, which may involve aging, solvent exchange, and any additional chemical modifications. Of course, aerogels may be prepared from a variety of precursors resulting in organic, inorganic or hybrid organic-inorganic aerogels. Examples of inorganic aerogels include those based on silica, titania, zirconia, alumina, hafnia, yttria, ceria, carbides, nitrides and combinations thereof. Organic aerogels can be based on compounds such as but are not limited to: urethanes, resorcinol formaldehydes, polyimide, polyacrylates, chitosan, polymethylmethacrylate, members of the acrylate family of oligomers, trialkoxysilyl terminated polydimethylsiloxane, polyoxyalkylene, polyurethane, polybutadiane, melamine-formaldehyde, phenol-furfural, a member of the polyether family of materials or combinations thereof. Examples of organic-inorganic hybrid aerogels include, but are not limited to: silica-PMMA, silica-chitosan, silica-polyether or possibly a combination of the aforementioned organic and inorganic compounds. Published US patent applications 2005/0192367 and 2005/0192366 teach extensively of such hybrid organic-inorganic materials and are hereby incorporated by reference in their entirety.

Aerogels may be modified to better mitigate the radiative component of heat transfer. This can be accomplished by incorporating an opacifiying compound within the aerogel material during synthesis. Suitable opacifying compounds include but are not limited to: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

Aerogel materials may be reinforced with a fibrous structure to improve strength, flexibility and/or other properties. In such composites said fibrous structure may be viewed as interpenetrating with the aerogel material where the former may or may not be fully incorporated within the aerogel material. The fibrous structure may comprise organic polymer-based fibers (e.g. polyethylenes, polypropylenes, polyacrylonitriles, polyamids, aramids, polyesters etc.) inorganic fibers (e.g. carbon, quartz, glass, etc.) or both and in forms of, wovens, non-wovens, mats, felts, battings, lofty battings, chopped fibers, or a combination thereof. Aerogel composites reinforced with a fibrous batting, herein referred to as “blankets”, are particularly preferrable for applications requiring flexibility since they can conform to three-dimensional surfaces and provide very low thermal conductivity. Aerogel blankets and similar fiber-reinforced aerogel composites are described in published US patent applications 2002/0094426, 2002/0094426, 2003/077438; U.S. Pat. Nos. 6,068,882, 5,789,075, 5,306,555, 6,887,563, 6,080,475, 6,087,407, 6,770,584, 5,124,101, 5,973,015, 6,479,416, 5,866,027, 5,786,059, 5,972,254, 4,363,738, 4,447,345; published PCT application WO9627726, Japanese patent JP8034678 and U.K. Patent GB1205572 all hereby incorporated by reference, in their entirety. Some embodiments of the present invention utilize aerogel blankets, though similar aerogel composites as referenced may also be utilized.

Flexible aerogel composites are desirable in a variety of applications such as drop-in-replacements for existing materials. During flexure or general handling, certain physical damage including dusting can occur. Although such damage may be inconsequential as far as other physical properties (e.g. thermal conductivity) are concerned, it still represents a nuisance to handling and use. Embodiments of the present invention provide methods for mitigating such damage by using an organic polymer coating. It is further noted, that such coating may also assist in improving abrasion resistance, chemical resistance and shape forming for aerogel materials (and aerogel composites.)

Embodiments of the present describe coated aerogel materials and methods for preparing the same. In one aspect, an aerogel material according to the present invention is an independently standing bulk material which is subsequently coated. In other words, said aerogel material is not formed on a substrate from which it cannot be separated without sacrificing structural unity; such being the case with aerogel thin films as in the electronics industry. Coatings that are derived from deposition of aerogel particles (often with a binder) or precursor compounds subsequently processed to form aerogels are therefore also not of relevance here. Within the context of the present invention, an aerogel material as utilized herein results from drying one bulk wet gel material, with a substantially continuous matrix. This being in contrast to aerogel particles (e.g. beads) resulting from a dried aggregate of separate gel particulates.

In general, suitable polymers for coating aerogel materials includes most any hydrocarbon based organic polymers including thermoplastics and thermosets. Such polymers may be selected from but not limited to: polyimides, polyamides, polyarylamides, polybenzimidazoles, polybutylenes, polyurethanes, cellulose acetates, cellulose nitrates, ethylcelluloses, ethylenevinyl alcohols, polyperfluoroalkooxyehtylenes, fluorocarbons, polyketones, polyetherketones, liquid crystal polymers, Nylons, polyethers, polytherimide, polyethersulfone, natural rubbers, synthetic rubbers, acrylics (emulsions or solutions), nitriles, ethylene propylenes, ethylene propylene diene methylenes, polyethylenes, chlorosulfonated polyethylenes, neoprenes, hypalon, ethylene acrylics, viton, acrylonitrile-butadiene acrylate, acrylonitrile-butadiene styrene terpolymer, acrylonitrile-chlorinated polyethylene styrene terpolymer, acrylate maleic anhydride terpolymer, acrylonitrile-methyl methacrylate, acrylonitrile styrene copolymer, acrylonitrile styrene acrylate, bis maleimide, cellulose acetate, cellulose acetate butyrate, cellulose acetate proprionate, cellulose nitrate, cycloolefin copolymer, chlorinated polyethylene, chlorinated polyvinyl chloride, cellulose triacetate, chlorotrifluoroethylene, diallyl phthalate, ethylene acrylic acid copolymer, ethyl cellulose, ethylene chlorotrifluoroethylene, ethylene-methyl acrylate copolymer, ethylene n-butyl acetate, epoxy, ethylene propylene diene monomer rubber, ethylene propylene copolymer rubber, ethylene propylene rubber, expandable polystyrene, ethylene tetrafluoroethylene, ethylene vinyl acetate, ethylene/vinyl acetate copolymer, ethylene vinyl alcohol, fluorinated ethylene propylene, high density polyethylene, high impact polystyrene, high molecular weight high density polyethylene, low density polyethylene, linear low density polyethylene, linear polyethylene, maleic anhydride, methyl methacrylate/ABS copolymer, methyl methacrylate butadiene styrene terpolymer, medium density polyethylene, melamine formaldehyde, melamine phenolic, nitrile butadiene rubber, olefin modified styrene acrylonitrile, phenolic polymers, poly acetic acid, polyamide-imide, polyaryletherketone, polyester alkyd, polyanaline, polyacrylonitrile, polyaryl amide, polyarylsulfone, polubutylene, polybutadiene acrylonitrile, polybutadine, polybenzimidazole, polybutylene napthalate, polybutadiene styrene, polybutylene terephthalate, polycarbonate, polycarbonate/acrylonitrile butadiene styrene blend, polycaprolactone, polycyclohexylene terephthallate, glycol modified polycyclohexyl terephthallate, polymonochlorotrifluoroethylene, polyethylene, polyether block amide or polyester block amide, polyetheretherketone, polyetherimide, polyetherketone, polyetherketone etherketone ketone, polyetherketoneketone, polyethylene naphthalene, polyethylene oxide, polyethersulfone, polyethylene terephthalate, glycol modified polyethylene terephthalate, perfluoroalkoxy, polyimide, polyisoprene, polyisobutylene, polyisocyanurate, polymethactylonitrile, polymethylmethacrylate, polymethylpentene, paramethylstyrene, polyoxymethylene, polypropylene, polyphthalamide, chlorinated polypropylene, polyphthalate carbonate, polyphenylene ether, polymeric polyisocyanate, polyphenylene oxide, polypropylene oxide, polyphenylene sulfide, polyphenylene sulfone, polypropylene terephthalate, polystyrene, polystyrene/polyisoprene block copolymer, polysulfone, polytetrafluoroethylene, polytetramethylene terephthalate, polyurethane, polyvinyl alcohol, polyvinyl acetate, polyvinyl butyryl, polyvinyl chloride, polyvinyl chloride acetate, polyvinylidene acetate, polyvinylidene chloride, polyvinylidene fluoride, polyvinyl fluoride, polyvinyl carbazole, polyvinyl alcohol, polyvinyl pyrrolidone, styrene acrylonitrile, styrene butadiene, styrene butadiene rubber, styrene butadiene styrene block copolymer, styrene ethylene butylene styrene block copolymer, styrene isoprene styrene block copolymer, styrene maleic anhydride copolymer, styrene methyl methacrylate, styrene/a-methyl styrene, styrene vinyl acrylonitrile, urea formaldehyde, ultrahigh molecular weight polyethylene, ultra low density polyethylene, unsaturated polyester, vinyl acetate, vinyl acetate ethylene, very low density polyethylene, expandable polystyrene, derivatives thereof, and co-polymers thereof.

In a preferred embodiment the coating comprises: polyethylene, kapton, polyurethane, polyester, natural rubber, synthetic rubber, hypalon, plastic alloys, PTFE, polyvinyl halides, polyester, neoprene, acrylics, nitrites, EPDM, EP, viton, vinyls, vinyl-acetate, ethylene-vinyl acetate, styrene, styrene-acrylates styrene-butadienes, polyvinyl alcohol, polyvinylchloride, acrylamids, phenolics or a combination thereof

In a specific embodiment, an aqueous based coating is employed. In general, any

suitable aqueous based coating can be used in the present invention. The term “aqueous based coating”, as used herein, refers to a coating that, prior to being dried, is water-dispersible or water-soluble. It is, therefore, to be understood that the term aqueous coating is used to refer to an aqueous binder in its wet or dry state (e.g, before or after the aqueous coating has been dried or cured, in which state the coating may no longer comprise water) even though the aqueous based coating may not be dispersible or soluble in water after the coating has been dried or cured. The particular aqueous based coating chosen should not substantially penetrate the porous surface of the a hydrophobic aerogel material. Preferred aqueous based coatings are those which, after drying, provide a water-resistant coating composition. Suitable such coating include, for example, acrylic coatings, phenolic coatings, vinyl acetate coatings, ethylene-vinyl acetate coatings, styrene-acrylate coatings, styrene-butadiene coatings, polyvinyl alcohol coatings, and polyvinyl-chloride coatings, and acrylamide coatings, derivatives, mixtures and co-polymers thereof. Such coatings can be used alone or in combination with suitable cross-linking agents. Preferred aqueous coatings are aqueous acrylic coatings.

In embodiments of the present invention, essentially any method for coating may be used as customary in the art. Examples of suitable coating techniques include but are not limited to: knife over roll coating, dip or saturation coating, reverse roll (all forms) coating, direct roll coating, gravure coating, printing rotary screen coating, curtain coating, die coating or extrusion, spray coating, transfer coating, electrostatic coating, brush coating, vapor deposition, flocking, hot knife or hot melt extrusion and methods combining the aforementioned.

In a particular embodiment, a polymeric coating can be applied on the surface of such aerogel materials. Application of such coatings can be accomplished by spraying a molten polymer, a polymer in solution, a polymer in suspension or combinations thereof through a nozzle or a similar device. U.S. Pat. Nos. 5,180,104, 5,102,484, 5,683,037, 5,478,014, 5,687,906, 6,488,773, 6,440,218 teach spray nozzles, spray guns and other devices that can be used for the in this embodiment, all hereby incorporated by reference. In yet another embodiment, a polymeric coating is applied via a dip coating method.

The thickness of the coating can vary depending on the end-use and properties of the selected polymers. In one embodiment, the thickness of the coating is between about 1 mil (0.0254 mm) and about 10 mil (0.254 mm). In another embodiment the thickness of the coating is greater than about 0.1 mm.

For certain applications it is desired to employ a flexible coating such that once coated the flexural modes of the aerogel material (or aerogel composite) are not significantly hindered. As such, polymeric coatings with elastic behavior or low stiffness are preferred.

In another embodiment, such polymeric films can be applied by way of laminating an existing film material on the surface of the aerogel materials. Solid film materials such as polyethylene, kapton, polyurethane, polyester, natural rubber, synthetic rubber, hypalon, plastic alloys, PTFE, polyvinyl halides, polyester, neoprene can be used as films to laminate on aerogel surfaces.

In a specific embodiment, the coating is adhered directly onto the aerogel material or aerogel composite. That is no intermediate layer is deposited or formed between the aerogel and the coating.

In another embodiment, the surface of the aerogel material or aerogel composite is modified prior to coating. Surface treatment methods include plasma treatment, corona treatment, or other chemical modifications. This procedure may aid in deposition of the desired coating for instance to achieve for example better deposition of the coating, more uniform thickness or better adhesion to the aerogel.

In yet another embodiment, the coating also comprises fibers. The fibers may be in chopped form and can have different deniers and compositions.

Once applied, a coating may also be subjected to other processing steps such as drying, curing and sintering for reasons such as solvent removal, better adhesion to the aerogel, improved mechanical properties and many others. One non-limiting mode of practicing embodiments of the present invention involves a motorized conveyor along with one or more spraying systems and one or more temperature treatment units preferably ovens and other mechanical apparatuses to automate the process in an industrial environment. The flexible aerogel is fed into the system through the moving conveyor element which takes the aerogel to a spraying system. Spraying system may consist of one or more spray heads whose spray characteristics can be individually controlled. The heat treatment units such as infra red or UV ovens provide the curing/drying to the coating. Spraying and heat treatment units can be located consecutively or in any combinations to provide the desired thickness and finish on the coated flexible aerogels. When solvents are used in the spraying process, appropriate equipment such as hoods and VOC reduction apparatuses may be used.

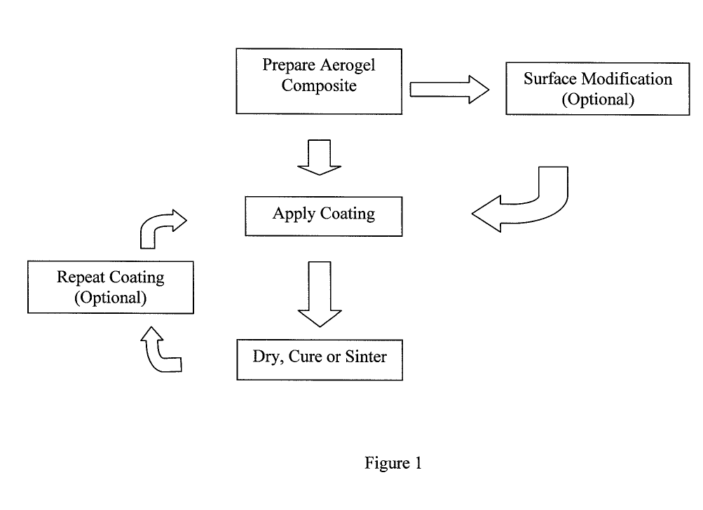

The accompanying figures also assist in illustrating certain embodiments of the present invention. As depicted in FIG. 1 an aerogel composite is prepared, optionally surface-modified, coated and, dried, cured or sintered. The coating and subsequent treatment may be repeated for as many iterations as desired. It is noted that the final post-coating processes may not be required for some embodiments wherein the coating is effective as applied. That is, the coating properties do not required further modification after deposition. In some instances the coating may dry or cure under ambient atmospheres.

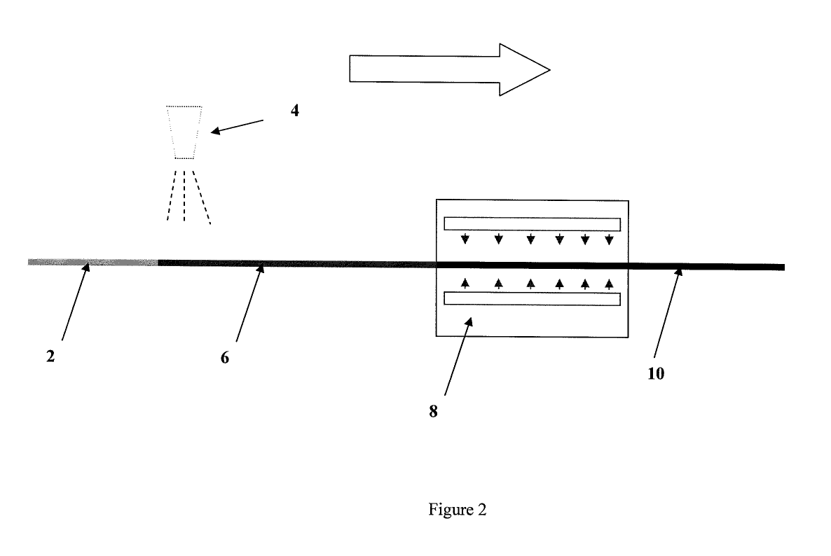

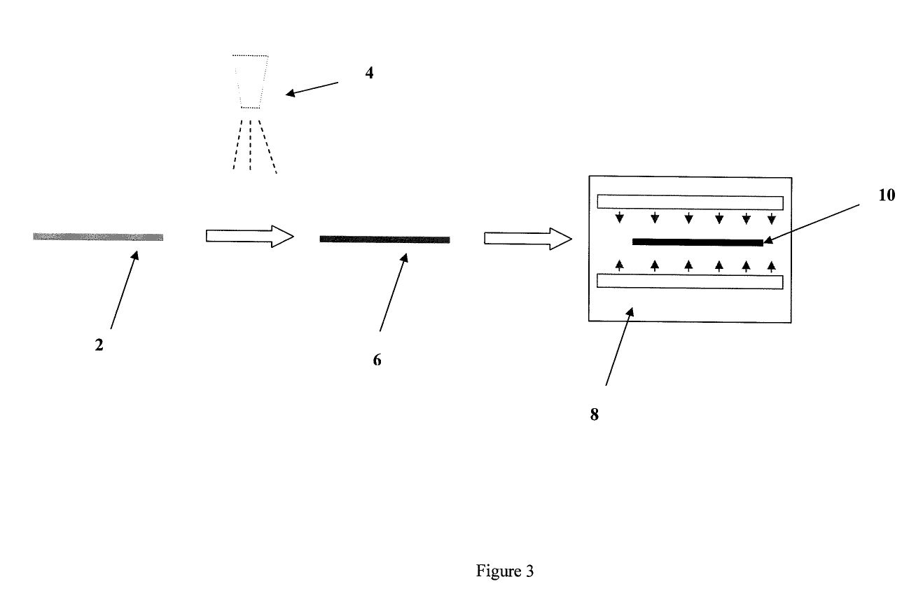

FIG. 2 illustrates a continuous process for coating an aerogel composite wherein the uncoated aerogel composite 2 is coated with a coating mechanism 4, exemplified by spray coating without any implied limitation. The coated aerogel composite 6 is then conveyed though an oven 8 resulting in the finished coated aerogel composite 10. FIG. 3 similarly displays a coating process with the exception of being a discontinuous method. Accordingly, a discrete piece of aerogel composite is coated and processed in a serious of independent steps.

Such systems can be designed to be operated horizontally or vertically. When the coating is desired on both sides of the aerogel composite, it may be advantageous to position the system vertically such that coating on both sides is accomplished equally. Certain embodiments of the present invention are further illustrated in the non-limiting examples below.

### EXAMPLE 1

A Binks pressure pot sprayer was filled with a water based acrylic coating manufactured by Acrytech Coatings Co.(product code XTHX2). The pressure was set to 4 psi in the pressure pot. Once the polymer started flowing from the sprayer, the atomization air was turned up until the desired atomization was achieved. The corresponding pressure was approximately 15 psi. The coating was then sprayed onto an 8 in×8 in sample of Spaceloft® (commercially available from Aspen Aerogels Inc.) until a thin coat was achieved. The sample was further heat treated using a heat gun until the coating was completely dried. This spraying and drying process was repeated until the desired thickness or layers were achieved.

### EXAMPLE 2

A Naptha based synthetic rubber coating manufactured by Plastidip International, Inc. (Product code: Plastidip) was applied using the same procedure as the one outlined in Example 1. The sample was allowed to air dry.

### EXAMPLE 3

Specseal AS205 latex coating, manufactured by STI Firestop, was applied using the same procedure as the one outlined in Example 1. This coating was then allowed to air dry. The coating was done in multiple layers allowing each layer to dry before the next layer was applied. This coating was also applied in one single layer to the desired thickness (same thickness as the multiple layer method, 2-4 mils thick). This sample was then allowed to air dry.

What is claimed is:

1. A composite comprising:
an aerogel material;
a fibrous structure interpenetrating with said aerogel material; and
a coating comprising a polymeric material disposed about at least one surface of said aerogel material.

2. The composite of claim 1 wherein the coating is aqueous based.

3. The composite of claim 1 wherein the coating comprises a cross-linking agent.

4. The composite of claim 1 wherein the coating comprises an organic solvent.

5. The composite of claim 1 wherein the coating is acrylic based.

6. The composite of claim 1 wherein the polymeric material comprises a powder.

7. The composite of claim 1 wherein the coating comprises: polyethylene, kapton, polyurethane, polyester, natural rubber, synthetic rubber, hypalon, plastic alloys, PTFE, polyvinyl halides, polyester, neoprene, acrylics, nitrites, EPDM, EP, viton, vinyls, vinyl-acetate, ethylene-vinyl acetate, styrene, styrene-acrylates styrene-butadienes, polyvinyl alcohol, polyvinylchloride, acrylamids, phenolics or a combination thereof.

8. The composite of claim 1 wherein the fibrous structure comprises organic polymer-based fibers, inorganic fibers or a combination thereof.

9. The composite of claim 8 wherein the fibrous structure is in a woven, non-woven, mat, felt, batting, chopped fibers or a combined form.

10. The composite of claim 1 wherein the aerogel material comprises an organic, inorganic or hybrid organic-inorganic material.

11. The composite of claim 10 wherein the aerogel material comprises silica, titania, zirconia, alumina, hafnia, yttria, ceria, carbides, nitrides or a combination thereof.

12. The composieof claim 10 wherein the aerogel material comprises urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, melamine-formaldehyde, phenol-furfural, a polyether or combinations thereof.

13. The composite of claim 10 wherein the aerogel material comprises silica-PMMA, silica-chitosan, silica-polyether or any combination thereof.

14. The composite of claim 1 where in the aerogel comprises an opacifying compound.

15. The composite of claim 14 wherein the opacifying compound is B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

16. A method of preparing a composite material comprising:
Substantially incorporating a fibrous structure within an aerogel material thereby forming a composite; and
coating at least one side of said composite with a polymeric material.

17. The method of claim 16 further comprising the step of curing the coating.

18. The method of claim 16 further comprising the step of heat treating the coating.

19. The method of claim 16 wherein the coating is applied using knife over roll coating, dip coating, saturation coating, reverse roll coating, direct roll coating, gravure coating, printing rotary screen coating, curtain coating, die coating extrusion coating, spray coating, transfer coating, electrostatic coating, brush coating, vapor deposition, flocking, hot knife coating, or hot melt coating.

20. The method of claim 16 wherein the coating is aqueous based.

21. The method of claim 16 wherein the coating comprises a cross-linking agent.

22. The method of claim 16 wherein the coating comprises an organic solvent.

23. The method of claim 16 wherein the coating is acrylic based.

24. The method of claim 16 wherein the polymeric material comprises a powder.

25. The method of claim 16 wherein the coating comprises: polyethylene, kapton, polyurethane, polyester, natural rubber, synthetic rubber, hypalon, plastic alloys, PTFE, polyvinyl halides, polyester, neoprene, acrylics, nitrites, EPDM, EP, viton, vinyls, vinyl-acetate, ethylene-vinyl acetate, styrene, styrene-acrylates styrene-butadienes, polyvinyl alcohol, polyvinylchloride, acrylamids, phenolics or a combination thereof.

26. The method of claim 16 wherein the fibrous structure comprises organic polymer-based fibers, inorganic fibers or a combination thereof.

27. The method of claim 24 wherein the fibrous structure is in a woven, non-woven, mat, felt, batting, chopped fibers or a combined form.

28. The method of claim 16 wherein the aerogel material comprises an organic, inorganic or hybrid organic-inorganic material.

29. The method of claim 26 wherein the aerogel material comprises silica, titania, zirconia, alumina, hafnia, yttria, ceria, carbides, nitrides or a combination thereof.

30. The method of claim 16 wherein the aerogel material comprises urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, melamine-formaldehyde, phenol-furfural, a polyether or combinations thereof.

31. The method of claim 26 wherein the aerogel material comprises silica-PMMA, silica-chitosan, silica-polyether or any combination thereof.

32. The method of claim 16 where in the aerogel comprises an opacifying compound.

33. The method of claim 30 wherein the opacifying compound is B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.
